(19) United States
(12) Patent Application Publication
(10) Pub. No.: US 2025/0230872 A1
(43) Pub. Date: Jul. 17, 2025

(54) METHOD FOR OPERATING A SELF-PROPELLED ROAD CONSTRUCTION MACHINE, IN PARTICULAR A RIDE-ON GROUND COMPACTION MACHINE, AND SELF-PROPELLED ROAD CONSTRUCTION MACHINE, IN PARTICULAR A RIDE-ON GROUND COMPACTION MACHINE

(71) Applicant: BOMAG GMBH, Boppard (DE)

(72) Inventors: Alexander DELZEIT, Boppard (DE); Albert KRÖBER, Boppard (DE)

(21) Appl. No.: 18/991,996

(22) Filed: Dec. 23, 2024

(30) Foreign Application Priority Data
Jan. 12, 2024 (DE) 102024100915.2

(51) Int. Cl. F16H 61/4165; E01C 19/28

(52) U.S. Cl. CPC F16H 61/4165; E01C 19/286; E01C 2301/30

(57) ABSTRACT

A method for operating a self-propelled road construction machine, in particular a ride-on ground compaction machine, and a self-propelled road construction machine, in particular a ride-on ground compaction machine.

### FIELD

The invention relates to a method for operating a self-propelled road construction machine, in particular a ride-on ground compaction machine, and a self-propelled road construction machine, in particular a ride-on ground compaction machine.

### BACKGROUND

Generic road construction machines include, for example, ground milling machines, in particular road cold milling machines, and ground compaction machines, in particular road rollers, for example so-called tandem rollers, rubber-tired rollers or single-drum rollers. Ground compaction machines with a driver's cab surrounding an operator platform are known. Alternatively, these machines, especially comparatively smaller ground compaction machines, may be equipped with an open operator platform, which, however, may in some cases comprise at least an operator platform roof. Finally, hand-guided ground compaction machines are known, which are operated by an operator walking along with the machine. Machines where the operator rides with the machine on an operator platform are also referred to as ride-on ground compaction machines. The present invention relates to self-propelled road construction machines where the operator sits or stands on the machine during traveling and working operation and travels with it.

Road construction machines are generally used for the construction and/or renovation of pathways, roads, runways and/or squares. Ground compaction machines are used in road and pathway construction to compact a subgrade or ground, for example asphalt layers or soil. For this purpose, the ground compaction machines typically have one or more compaction drums, which are configured, for example, as roller drums with a hollow cylindrical base body and with which the ground compaction machines move over the ground. Such compaction drums can also be set into vibration, for example, by a vibration exciter, typically an imbalance exciter, in order to influence compaction and enable dynamic compaction in addition to a purely static compaction. It is also possible to use a compaction drum in combination with wheels, in particular rubber tires, or other travel units. In addition, ground compaction machines are known that have only wheels, such as so-called rubber-tired rollers, which are also used in road construction.

Such road construction machines are usually self-propelled and comprise a drive motor. Said drive motor is often a combustion engine, for example a diesel combustion engine. A common drive concept for such ground compaction machines is that the drive motor drives one or more hydraulic pumps of a hydraulic system, which in turn transmit hydraulic drive energy to hydraulic consumers, for example traction motors and/or working unit motors, which drive, for example, one or more vibration exciters, an edge cutter, a spreader, a milling drum, a fan of a dust extraction system, etc. In known configurations, the hydraulic system comprises suitable line connections for this purpose. The hydraulic pump responsible for a traction drive hydraulic circuit is also referred to as a traction pump. Furthermore, such road construction machines may have a hydraulically driven steering system, especially in the case of so-called articulated road construction machines, as are known per se in particular for road rollers. The hydraulic pump responsible for a steering hydraulic circuit is also known as a steering hydraulic pump.

In view of the increasingly stringent emission regulations for users and manufacturers of such road construction machines, road construction machines of this type are increasingly being equipped with one or more electric motors, even to the extent of completely replacing the conventional combustion engine with one or more electric motors. In particular, the primary drive unit, i.e., the main drive power source of the road construction machine, may also be an electric motor. Such road construction machines may still include a hydraulic system and thus comprise an electrohydraulic drive architecture.

Hydraulic systems have already proven their worth and offer many advantages. However, especially at the start of operation, when the hydraulic fluid of the hydraulic system is still relatively cold, the increased viscosity associated with the low temperature of the hydraulic fluid can be disadvantageous. On the one hand, this can lead to increased wear on parts of the hydraulic system. On the other hand, the actuation of individual control elements, such as performing steering movements of a hydraulic steering system via a steering wheel, can be difficult. It is therefore common practice for road construction machines with combustion engines to run in idle mode for a period of time at the start of operation, thereby heating up the hydraulic fluid. However, such idling is not only detrimental from an environmental point of view, but is also not identically possible when one or more electric motors are used, as electric motors do not usually have the option of idling in the same way as combustion engines. Moreover, users of such road construction machines find it uncomfortable to have to be present on the operator platform during this warm-up phase as, for reasons of operational safety, the drive motor of the road construction machine can only be started up when an operator is present on the operator platform. This can be determined by a so-called operator detection device, for example a driver's seat switch, which is activated when the driver is sitting in the driver's seat.

### SUMMARY

Against this background, it is the object of the invention to increase the operating comfort of a road construction machine.

The object is achieved with a method for operating a self-propelled road construction machine, in particular a ride-on ground compaction machine, and a self-propelled road construction machine, in particular a ride-on ground compaction machine, according to the independent claims. Preferred embodiments are cited in the dependent claims.

In a first aspect, the invention thus relates to a method for operating a self-propelled road construction machine, in particular a ride-on ground compaction machine. A generic road construction machine comprises an electrohydraulic drive system with an electric motor as the drive unit. The drive system may, for example, drive one or more travel units, in particular one or more wheels and/or roller drums and/or crawler tracks, and/or one or more working units. Such a working unit may be, for example, a vibration exciter, a steering device, a unit that can be adjusted by a linear actuator, such as an edge cutter or a lifting cylinder, a conveyor belt drive or the like. The electric motor, for example a synchronous or asynchronous motor, is connected to an energy storage device configured to store electrical energy, in particular an accumulator. Said accumulator may comprise several subsections. An inverter may also be provided. The electric motor can therefore draw electrical energy from the energy storage device and be driven by it. The electric motor may be the primary drive unit of the road construction machine. The road construction machine may be designed without an internal combustion engine so that all the energy required to operate the road construction machine is primarily provided by one or more electric motors.

The generic road construction machine further comprises at least one hydraulic pump which can be driven by the electric motor and which, when driven by the electric motor, draws hydraulic fluid from a hydraulic fluid reservoir and delivers it into a hydraulic fluid reservoir via a hydraulic system. The hydraulic pump may be a fixed displacement pump or a variable displacement pump with variable delivery volume per revolution and/or time unit. In particular, the hydraulic system may be an open hydraulic circuit where the hydraulic pump draws hydraulic fluid from the hydraulic fluid reservoir at at least one extraction point and delivers it back into the hydraulic fluid reservoir via at least one, possibly separate, outlet point. The hydraulic circuit may also be a closed hydraulic circuit, although in this case, for example to compensate for leakage losses, leakage oil is collected in the hydraulic fluid reservoir and hydraulic fluid is fed into the closed hydraulic fluid circuit from the hydraulic fluid reservoir. The hydraulic fluid is conveyed through at least a part of the hydraulic system between the extraction point and the outlet point. For this purpose, the hydraulic system may comprise suitable pipe and/or hose lines. The hydraulic fluid reservoir may be a hydraulic fluid tank.

A controllable throttle valve within the hydraulic system is also part of the generic road construction machine. Within is to be understood herein as meaning that the hydraulic fluid delivered by the hydraulic pump is pumped through a line section having a line cross-section or flow cross-section that can be changed by the throttle valve. The throttle valve therefore refers to a device that can be used to at least temporarily create a flow obstruction within the hydraulic system for the hydraulic fluid. For this purpose, the throttle valve may, for example, be configured such that it at least temporarily restricts the flow or line cross-section available for the hydraulic fluid within the hydraulic system compared to the flow or line cross-sections adjacent to the throttle valve in and against the direction of flow of the hydraulic fluid through the throttle valve. It is essential that the throttle valve can be adjusted at least between a passive position and at least one warm-up position. The throttle valve can thus vary the flow or line cross-section defined by it between at least two cross-sectional areas of different size in terms of the flow-through cross-sectional area (i.e., perpendicular to the main direction of flow), wherein the position in which the throttle valve has a larger flow-through cross-sectional area is referred to as the passive position, and the position in which the throttle valve has a relatively smaller flow-through cross-sectional area is referred to as the warm-up position. With regard to the flow-through cross-sectional area in this state of the throttle valve, the passive position may be configured such that the throttle valve itself does not provide any flow obstruction in the passive position, i.e., that the flow-through cross-sectional area corresponds to at least the flow-through cross-sectional area of the flow or line cross-sections adjacent to the throttle valve in and against the direction of flow of the hydraulic fluid through the throttle valve, or is even greater. It is possible that the throttle valve can be adjusted such that it can only be adjusted back and forth between the two end positions “passive position” and “warm-up position”. However, it is also possible for the throttle valve to be able to assume more than one warm-up position, or to be adjustable within a warm-up position range.

According to the invention, the road construction machine may further comprise a control device which controls the adjustment of the throttle valve between the passive position and the at least one warm-up position. The control device may, for example, be part of a machine control system of the road construction machine. This can be a computer device, for example.

The road construction machine configured to carry out the method according to the invention further comprises a machine activation device which can be adjusted by an operator of the road construction machine to adjust the road construction machine between an activation state and a deactivation state. In the deactivation state, all drive units required for traveling and working operation of the road construction machine are deactivated, in particular currentless or de-energized. Specifically, in this state, the at least one hydraulic pump cannot deliver any hydraulic fluid. The deactivation state typically occurs when the road construction machine is to be transported and/or is not used for comparatively long periods of time, for example often overnight and/or during longer breaks. In particular, the deactivation state may be an operating state in which the supply of electrical energy to one or more components of the road construction machine provided by the energy storage device during regular operation of the road construction machine is disconnected. For example, a battery disconnect switch that actually works mechanically, in particular one that can also be operated manually, may be provided for this purpose. Additionally or alternatively, however, isolating electronics may also be used to achieve this disconnection, at least functionally. In the activation state, on the other hand, the road construction machine can be put into operation by an operator, even if it may be necessary to fulfill further conditions, such as a certain position or localization of the operator on the road construction machine, the release of a parking brake, etc., in some cases. In the activation state, however, there is already a more comprehensive possible supply of electrical energy drawn from the energy storage device to one or more loads compared to the deactivation state. In the activation state, for example, one or more lighting devices, displays and/or touchscreen functions that are de-energized or inactive in the deactivation state may already be possible. The activation and/or deactivation state may also depend on the respective function. To “drive”, for example, it may be necessary for the driver to be seated and a control lever to be released from a brake detent in order to transition to the activation state. For a “work function”, such as the actuation of an edge cutter and/or the activation of a vibration function/imbalance exciter, a transition from the deactivation state to the activation state may only be possible with a drive lever positioned in a brake detent.

In addition, a road construction machine configured to carry out the method according to the invention comprises a parking brake device that can be adjusted between a braking position and a release position. In the braking position, the parking brake device exerts a braking effect directly or indirectly on at least one of the travel units, so that the road construction machine is prevented from traveling or rolling. This can be achieved, for example, by means of a suitable positive engagement and/or frictional contact. The parking brake device may be configured as a claw or multi-disc brake, for example.

The road construction machine may further have a braking state detection device configured to at least detect an activated braking position and/or an activated release position of the parking brake device. The braking state detection device can therefore be used to detect and monitor, for example by means of one or more suitable sensors, which of the two positions the parking brake device is currently in. Such a sensor may, for example, be a contact switch or the like. The signal detected by the braking state detection device can be transmitted to the control device.

Based on the above-described basic structure of a road construction machine on which the method according to the invention is to be based, a core aspect of the invention lies in a method for heating hydraulic fluid. On the one hand, this method can be used to heat the hydraulic fluid without requiring the operator to be present on the operator platform in a specific operating position. On the other hand, compliance with existing requirements for the operational safety of such a road construction machine can be ensured at the same time. In this context, the operating position refers to a position of the operator within or on the road construction machine that he is intended to assume during traveling and working operation of the road construction machine. This position may often be a seated position in a driver's seat comprised by the road construction machine, for example. However, this does not mean that the operation of partial functions of the road construction machine in particular is generally only possible from the operating position, especially to the extent that the road construction machine is not operated as intended.

In order to heat the hydraulic fluid when the machine is not in traveling and working operation, starting from a road construction machine in the deactivation state, the method comprises an initial step a) of adjusting the machine activation device from the deactivation state to the activation state by the operator of the road construction machine. This can be done directly by the operator, for example, by manually actuating a control element located on the road construction machine. Additionally or alternatively, it is also possible for the control device of the road construction machine to have a timer function which an operator can use to specify a time in the future at which the machine control system then switches the road construction machine from the deactivation state to the activation state. This function can be provided by the control unit. Additionally or alternatively, the adjustment may also be carried out by the operator via a wireless signal connection via a mobile unit, in which case suitable communication means are then included, via which the operator transmits a signal for adjusting the road construction machine from the deactivation state to the activation state from his mobile unit, for example a smartphone, to the road construction machine. In this case, the method therefore also includes transmitting a switching signal from the deactivation state to the activation state from the mobile unit to the road construction machine.

However, if the road construction machine has entered the activation state, it is not yet fully operational for this reason alone. Instead, the method now includes a step b) of detecting and transmitting, by the braking state detection device to the control device, whether the parking brake device is in the braking position or the release position. In the braking position, the parking brake device is in a position in which it performs a parking brake function, in particular such that the construction machine can neither move actively in a self-propelled manner, nor be passively moved externally. Detecting the current position of the parking brake device is performed with the aid of the braking state detection device and may, on the one hand, only include an actual detection of adoption of the braking position. Thus, if it is currently detected that the braking position is not adopted, it can then be assumed that the parking brake device is in the release position. Alternatively, it is conversely also possible to provide an actual detection of the release position only, so that the braking position is assumed if the release position is not detected. Preferably, adoption of both the release position and the braking position is detected. Specifically, the braking state detection device may have one or more suitable sensors for this purpose, such as one or more position sensors, contact switches, contactless, in particular inductive, proximity switches, etc. In one embodiment, for example, a separate actuating element, such as a lever, may be present, which is only provided for activating/deactivating the parking brake device, and the actuating position of which is detected. Alternatively, a multifunctional actuating element may also be provided, which enables at least one further function in addition to activating/deactivating the parking brake device. Among other things, it is possible to provide a drive lever that enables control of the travel speed and/or direction of travel (forwards-backwards). This can be done, for example, by deflecting the drive lever in or against a forward direction. At the same time, this drive lever may be adjustable, in particular from a defined zero position in which no travel movement is specified, into a position that activates the parking brake device, in particular one that is oriented transversely to the direction of travel and/or travel speed control direction on the drive lever. The activation and/or deactivation of the parking brake device can then be detected, for example, by detecting the position of the drive lever. Additionally or alternatively, one or more relative positions of the brake elements of the parking brake device that actually interact mechanically with each other may also be detected by means of suitable sensors, for example the relative position and/or the adoption of a specific position of the claws of a claw brake, etc.

Assuming a typical start-up situation of a road construction machine that has been inactive for a long period of time, where the hydraulic fluid has cooled down to the ambient temperature, for example, and is therefore well below a normal operating temperature of the hydraulic fluid, a step c) may now comprise heating the hydraulic fluid in a targeted manner without the physical presence of the operator on the road construction machine being required. For this purpose, said step comprises controlling the position of the throttle valve between the passive position and the warm-up position by the control device in a stationary warm-up mode. However, this is only possible if the road construction machine is in the activation state, which can be queried separately by the control device, for example, if the control device is also energized when the road construction machine is in the deactivation state and is performing one or more monitoring functions, such as the timer function. In the event that the control device is also de-energized and therefore inactive in the deactivation state, the actual adoption of the activation state does not have to be queried separately by the control device. Controlling the throttle valve in the stationary warm-up mode further depends on detection signals from the braking state detection device. In this mode, the control device therefore also queries the current state of the parking brake device or checks whether the parking brake device is currently in the braking position or in the release position. Then, in particular only, if the parking brake device is in the activated braking position, the control device activates the delivery of hydraulic fluid by the hydraulic pump driven by the electric motor in the stationary warm-up mode and moves the throttle valve to the at least one warm-up position. This delivered hydraulic fluid flows at least partially, preferably completely, through the throttle valve. Because the throttle valve is in the warm-up position and therefore in a position that represents an obstacle to the flow of hydraulic fluid, the hydraulic fluid is heated as it passes through the throttle valve by converting mechanical or hydraulic energy into thermal energy. The heated oil can be fed into the traction drive hydraulic circuit. At the same time, the parking brake device in the braking position reliably prevents this hydraulic fluid flow from moving the road construction machine as long as a heating of the hydraulic fluid in stationary mode is desired. Overall, the stationary warm-up mode can therefore run without the need for an operator to be permanently present on the road construction machine for safety reasons. If the operator then starts up the road construction machine a little later, i.e., when the hydraulic fluid has at least ideally already warmed up to a significant degree, full operating comfort is ideally available immediately and signs of wear on the hydraulic components can be reduced at the same time.

The stationary warm-up mode may be configured such that it can be changed solely between an activated and a deactivated operating state. In other words, it can be controlled purely between a switched-on and a switched-off state. However, this can lead to the stationary warm-up mode also pumping hydraulic fluid through the throttle valve in the warm-up position in phases in which the temperature of the hydraulic fluid is already sufficiently high. If the warm-up mode is maintained during these phases, this reduces the energy efficiency of the road construction machine accordingly. It is therefore preferred if the hydraulic pump is only activated by the control device, in particular when the warm-up mode has been activated by the operator, if a state parameter influencing the current viscosity of the hydraulic fluid and/or an operating parameter dependent on the current viscosity of the hydraulic fluid is outside a defined range. One state parameter that influences the current viscosity of the hydraulic fluid is in particular the temperature of the hydraulic fluid. The lower the temperature of the hydraulic fluid, the higher its viscosity. The temperature of the hydraulic fluid may therefore be determined by means of a suitable sensor, for example by means of a temperature sensor, and transmitted to the control device. A temperature limit may be defined which should be exceeded in order to obtain a sufficiently low viscosity. The control device only activates the at least one hydraulic pump and/or the throttle valve only in phases of the stationary warm-up mode in which the current temperature of the hydraulic fluid is below this temperature limit. An operating parameter dependent on the current viscosity of the hydraulic fluid may be, for example, a pump resistance and/or a pump torque to be applied and/or an adjustment torque to be applied for an adjustment movement, for example for an adjustment movement of one or more hydraulically actuatable components, in particular a hydraulic steering system, and/or a pressure in at least one area of the hydraulic system. These can also be detected, monitored and/or transmitted to the control device by means of suitable sensors, in particular load sensors, and can be decisive for activating the hydraulic pump in stationary warm-up mode. One or more limits may also be defined for this, the exceeding or falling below of which indicates that the current viscosity is still too high and therefore the current temperature of the hydraulic fluid is still too low and/or vice versa. Additionally or alternatively, the activated hydraulic pump can be deactivated by the control device if the state parameter influencing the current viscosity of the hydraulic fluid and/or the operating parameter dependent on the current viscosity of the hydraulic fluid is within a defined range, in particular if the temperature of the hydraulic fluid is above a temperature limit or an alternative state parameter is beyond a defined limit. Whether a limit to be fallen below and/or exceeded and/or a value range to be adopted for activating and/or deactivating the hydraulic pump and/or the throttle valve is taken into account by the control device results in all variants in hydraulic fluid only being pumped through the throttle valve in stationary warm-up mode if this is necessary to obtain optimum operating conditions. As a result, operating phases may also occur in stationary warm-up mode in which no hydraulic fluid is pumped through the throttle valve when it is not required, so that the overall energy balance of the road construction machine can be further improved. Additionally or alternatively, at least one or more individual properties of the hydraulic fluid used may be stored and/or entered by the operator and the above-mentioned processes may also depend on said one or more properties. This may also include input of a specific type of hydraulic fluid or the like.

Generally, it is possible for the throttle valve to be adjustable between exactly one passive position and exactly one warm-up position. However, it can be advantageous if, in addition to the one passive position, the throttle valve is adjustable within a variable adjustment range to at least two different warm-up positions, wherein one warm-up position has a higher throttling effect than the other warm-up position, or they have different line cross-sections. This enables further optimization of the operation of the road construction machine in stationary warm-up mode, such as the current state of charge of the energy storage device, particularly fast or alternatively particularly energy-efficient warm-up of the hydraulic fluid, etc. The throttle valve may be configured as a controllable throttle valve, for example. From a functional point of view, it is advantageous if functions downstream of the throttle valve in the hydraulic fluid circuit are not taken into account in terms of performance.

As will be described in more detail below, the use of the throttle valve does not have to be limited to heating up the hydraulic fluid in stationary warm-up mode, but may in individual cases also extend to warm-up purposes and/or other tasks, for example for braking, during traveling and working operation of the road construction machine. In this case, it is preferred if the at least one warm-up position with the higher throttle effect compared to the other warm-up position can and will be set by the control device only if at least the parking brake device is in the activated braking position. On the one hand, this means that the throttle valve only achieves the maximum warm-up effect in stationary warm-up mode. On the other hand, this ensures that a throttle reserve is available in operating phases other than the stationary warm-up mode, in particular when the road construction machine is in traveling and working operation, which can be used for braking or similar purposes, for example, if necessary.

In addition to the stationary warm-up mode already described, which is only available when the parking brake device is in the braking position and the road construction machine is therefore stationary, the control device may also be operated in an operational warm-up mode. This operational warm-up mode is distinguished from the stationary warm-up mode by the fact that it can be used specifically to warm up the hydraulic fluid, possibly further, while the road construction machine is in traveling and working operation. This requires that in this case the road construction machine is not only in the activation state, but that the parking brake device is in the release position. In this constellation, the control device may adjust the position of the throttle valve to the at least one warm-up position for generating a braking torque and/or for heating hydraulic fluid within at least a part of the hydraulic system. The throttle valve may therefore be moved into a warm-up position by the control device specifically for the purpose of additional and/or faster heating of the hydraulic fluid in this operating phase. In particular, this may also be done depending on the state and/or operating parameters described above for the stationary warm-up mode. The additional or alternative use of the throttle valve to generate a braking torque is particularly useful if the road construction machine has an electrohydraulic drive train. In contrast to conventional road construction machines with an internal combustion engine, such as a diesel engine, for driving, it is not easily possible with electrohydraulic drive concepts to use a supporting torque from the internal combustion engine to brake the road construction machine. When braking or during downhill travel, for example, hydraulic traction motors of the road construction machine act as pumps so that a torque applied to the traction motors is transmitted to at least one traction pump, which then acts as a motor. The supporting torque of the combustion engine can be used in such road construction machines to support this torque applied to the at least one traction pump, so that the road construction machine can be decelerated overall (this effect is also commonly referred to as “engine braking”). An electric motor, on the other hand, is not suitable for reliably building up a supporting torque or braking torque that can be used to decelerate the road construction machine. For example, reduced supporting torques may occur depending on the state of charge of the battery or also depending on the power reduction of the electric motor and/or the inverter. However, the throttle valve can now be used in an electrohydraulic drive concept to increase the resistance at least locally within the hydraulic system for braking purposes. The throttle valve can thus be used in a dual function in the method according to the invention. On the one hand for targeted, in particular also selective, heating of the hydraulic fluid, especially when the road construction machine is stationary, and on the other hand as a braking device when the road construction machine is in traveling and/or working operation, for targeted generation of a braking torque if required. In order to achieve this functionality, in particular, a traction drive hydraulic pump, a working or operating hydraulic pump, in particular a steering hydraulic pump, and the electric motor are mechanically coupled together, for example in a tandem arrangement driven jointly by the electric motor.

The control device may control the throttling effect of the throttle valve such that it is greater in stationary warm-up mode than in operational warm-up mode. This can be advantageous, for example, because practically no power reserve of the electric motor needs to be kept available in stationary warm-up mode, and the throttling effect of the throttle valve can be used practically exclusively to heat the hydraulic fluid in this operating phase. In the operational warm-up mode, on the other hand, one or more hydraulic consumers may be or become activated, for example a traction drive hydraulic motor and/or a working unit drive hydraulic motor. It is therefore important that the available hydraulic drive energy is only eliminated by the throttle valve for heating purposes to such an extent that reliable and situation-adequate operation of the traction drive hydraulic motor and/or the working unit drive hydraulic motor is still ensured.

In a further preferred embodiment of the method according to the invention, the control device may control at least one safety function in relation to at least one hydraulically operable functional unit of the road construction machine in the operational warm-up mode and if the throttle valve is in a warm-up position, and for this purpose initiates an adjustment of the position of the throttle valve to increase the throttling effect of the throttle valve if a higher throttling effect compared to the operational warm-up mode is required to obtain the safety function. If the throttling effect of the throttle valve is used for several functions, in particular during operational warm-up mode, the control device and/or the throttle valve may receive conflicting requests. In this case, the control device may prioritize these requests in order to ensure that the throttle valve always has at least a sufficient throttling effect.

Specifically, for example, the control device, may prioritize a request signal for generating a braking torque, which ultimately represents a safety function, and a request signal for generating a warm-up power in operational warm-up mode. In other words, the control device weighs up control signals for generating a braking torque and control signals for heating the hydraulic fluid. According to the invention, control signals relating to the safety function are always prioritized over signals relating to heating purposes. However, particularly in the event that the throttling effect currently generated by the throttle valve in a warm-up position is already above the throttling effect currently requested by the safety function, it may be preferred for the control device to then maintain the existing throttling effect or the current position of the throttle valve in the warm-up position and thus not reduce it to the throttling effect currently only requested by the safety function. However, as soon as the throttling effect currently requested by the safety function exceeds the current throttling effect, the control device will increase the throttling effect of the throttle valve by adjusting the warm-up position. In this context, in particular, the control device may control the position of the throttle valve between the passive position and the warm-up position (also) depending on the detection signals from the braking state detection device or a service brake device that can be controlled separately from the parking brake device. Additionally (or alternatively), heat may also be introduced into the hydraulic circuit by an electrical heating unit at at least one point in the line system.

The road construction machine may have an operator platform from which the operator can control the traveling and working operation of the road construction machine. The operator platform may, for example, comprise a driver's seat and/or one or more control elements that can be manually operated by the operator on the operator platform. Road construction machines are known whose operational safety concept provides for an operator detection device that is provided on the operator platform and is configured to detect a presence and/or absence of an operator in an operating position on the operator platform. The purpose of such an operator detection device is in particular to ensure that the road construction machine can only be driven and operated or even started up if an operator is actually present on the operator platform for this purpose. A typical operator detection device may be a seat contact switch, for example, which is only activated when an operator is sitting in the driver's seat. The operator detection device thus detects and transmits to the control unit whether the operator is in the operating position on the operator platform. Typically, the control device and/or the operator detection device is configured such that practically all drive components of the road construction machine are then deactivated, in some cases even de-energized, as long as the operator detection device does not confirm the presence of an operator on the operator platform. This safety function may also have a timer function during operation, so that deactivation from the ongoing traveling and/or working operation of the road construction machine only takes place if no presence of an operator is detected by the operator detection device over a defined period of time. However, in order to enable operation of the road construction machine in stationary warm-up mode, contrary to this normally existing safety concept, the throttle valve may also be operated by the control device in stationary warm-up mode and/or in operational warm-up mode depending on whether the operator detection device detects an operator in the operating position or not. If, for example, the stationary warm-up mode is activated, and in the event that the parking brake device is moved to the release position and/or the operator detection device recognizes the presence of an operator, which in both cases indicates, on the one hand, a probable imminent termination of the stationary warm-up mode and possibly a transition to the operational warm-up mode and, on the other hand, a probable imminent start of traveling and/or working operation of the road construction machine, the control device may, as a precaution, change the position of the throttle valve being in a first warm-up position such that the pressure drop caused by the throttle valve, or the throttling effect of the throttle valve, is canceled to the passive position relative to the first warm-up position or is at least adjusted to a second warm-up position with a reduced throttling effect relative to the first warm-up position. Additionally or alternatively, for example, when the operational warm-up mode is active and the throttle valve is in a warm-up position, and in the event that the parking brake device moves from the release position to the braking position and/or the operator detection device no longer detects a previously detected presence of an operator, for example because the operator has left the operator platform or at least his operating position, the control device may adjust the throttle valve to the passive position or, if necessary, switch to the stationary warm-up mode, together with any necessary adjustment of the position of the throttle valve.

Preferred embodiments of the method according to the invention are also possible for the case that the road construction machine comprises a hydraulically actuated steering device. With regard to the general configuration of the hydraulic steering device, various configuration options are known. Apart from a power steering system, a particularly proven arrangement comprises a steering hydraulic pump that delivers hydraulic fluid in a steering hydraulic circuit through a steering orbitrol. In particular, the steering hydraulic pump may be operated as a fixed displacement pump and/or almost independently of the rest of the hydraulic system. When using a hydraulically actuated steering device, in particular as a hydraulic system for heating the hydraulic fluid, as described above, it is now possible that the control device controls the road construction machine in stationary warm-up mode such that in a variant a) if the operator detection device does not detect the presence of the operator in the operating position, a speed of the electric motor is reduced when the steering device is activated, in particular depending on the current warm-up position of the throttle valve, or a speed of the electric motor is limited to a maximum permissible steering operating speed. On the one hand, this enables hydraulic steering of the stationary road construction machine from outside the operating position provided for normal operation of the road construction machine, even in stationary warm-up mode. Specifically, especially in the case of so-called “ride-on road construction machines”, i.e., in particular, for example, road construction machines up to a total unladen weight of no more than 5 tons, an operator standing next to the road construction machine can adjust a steering control element located on the operator platform, for example a steering wheel and/or a steering lever, at least for steering purposes, which can be advantageous, for example, when positioning the road construction machines on a transport vehicle for transport purposes. At the same time, the above measures ensure that the hydraulic power available for the steering is comparatively low, which can significantly reduce the risk of accidents when actuated from outside the operating position and, in particular, from outside the road construction machine. Additionally or alternatively, it is possible that in a variant b) if the operator detection device detects the presence of the operator in the operating position, the electric motor is operated at a speed which is increased compared to at least one of the speeds from variant a), in particular also as long as the parking brake device is still in its braking position. This enables more powerful steering, which is acceptable if the operator is in the intended operating position.

In the event that the hydraulic pump is a steering hydraulic pump and that the hydraulic system comprises a traction drive hydraulic pump, it is possible that, in stationary warm-up mode, hydraulic fluid conveyed by the steering hydraulic pump from the hydraulic fluid reservoir is conveyed in the hydraulic system through at least a part of a steering hydraulic circuit and from there through at least a part of the traction drive hydraulic pump and from there into the hydraulic fluid reservoir. In particular, the hydraulic fluid delivered by the steering hydraulic pump may also be used and fed in for “cross flushing” and/or the leakage compensation of a traction drive hydraulic circuit provided for the traction drive hydraulic circuit in normal operation. An additional bypass line may also be provided for this purpose, which, in particular switched via a suitable hydraulic valve, only supplies hydraulic fluid from the steering hydraulic circuit to the traction drive hydraulic pump and/or into the traction drive hydraulic circuit when the stationary warm-up mode and/or operational warm-up mode is activated. However, as long as the road construction machine is in stationary warm-up mode, it is advantageous if the hydraulic fluid is delivered such that no traction drive power is generated at one or more hydraulic motors driven by the traction drive hydraulic pump. This can be achieved, for example, by means of suitable valve controls, which direct the hydraulic fluid past the hydraulic motors for this state and/or, if the hydraulic motors are configured as variable displacement motors, by completely swinging out the adjusting devices of the variable displacement motors so that the hydraulic fluid flowing through the variable displacement motors does not drive any motor movement of the variable displacement motors.

Road construction machines may include special working equipment, in particular hydraulically driven working equipment. In the case of road milling machines, for example, the rotational movement of a milling drum may be hydraulically driven. Road compaction machines may be equipped with one or more so-called vibration exciters. The hydraulic pump may therefore also be a vibration exciter drive hydraulic pump, and the hydraulic system may comprise a vibration hydraulic system with a vibration drive motor driven by the vibration exciter drive hydraulic pump. For this particular configuration of the hydraulic system, it may be advantageous if the controllable throttle valve, for example in the form of a pressure-limiting valve, is arranged in a bypass line bypassing the vibration drive motor, wherein in stationary warm-up mode or in operational warm-up mode at least a portion of the hydraulic fluid delivered from the hydraulic fluid reservoir by the vibration exciter drive hydraulic pump is delivered through the controllable throttle valve and from there into the hydraulic fluid reservoir while bypassing the vibration drive motor. In this way, it is also possible to use the vibration exciter hydraulic circuit to heat the hydraulic fluid. If the vibration drive motor is a variable displacement motor, the bypass line can be dispensed with. However, constant motors are usually used here, so that any flow through the hydraulic motor has a drive effect on the vibration assembly. However, particularly for the stationary warm-up mode, it is advantageous if it is ensured that no vibrations are then generated at the vibration assembly.

The overall energy management of the road construction machine is of particular importance for road construction machines whose primary drive is provided by the electric motor or which do not have an internal combustion engine, as the charging cycles required to recharge the energy storage device are generally still comparatively time-consuming. For this reason, it is preferred if the control device only allows the stationary warm-up mode when the state of charge of the energy storage device is above a state of charge limit. This prevents the energy storage device from being discharged due to the road construction machine being operated in stationary warm-up mode and the road construction machine then no longer being able to move under its own power. Additionally or alternatively, the control device may control the warm-up position of the throttle valve depending on the current state of charge of the energy storage device. If the state of charge of the energy storage device is still comparatively high, a more energy-intensive stationary warm-up mode or a positioning of the throttle valve with a comparatively high throttling effect can be accepted more readily than if the energy storage device only has a comparatively low state of charge.

A further aspect of the invention relates to a self-propelled road construction machine, in particular a ride-on ground compaction machine. In order to avoid repetition, reference is made to the preceding disclosure on the method according to the invention with regard to the device features included in a generic road construction machine. According to the invention, the road construction machine is configured to carry out the method according to the invention, as described above.

Preferably, the self-propelled road construction machine, in particular ride-on ground compaction machine, comprises a machine activation device with an operating device that can be actuated from outside the operator platform of the road construction machine. This operating device may be a mobile unit, in particular a smartphone, wherein the road construction machine is then configured for communication, in particular wireless communication, for example via WLAN, NFC etc., in order to receive signals from the mobile unit, in particular to be able to exchange signals with it. Additionally or alternatively, a manually operated control element may also be included in the operating device, for example a switch and/or button, in particular a key-operated switch or a keypad. In this case, an operator can actuate the machine activation device without having to enter the operator platform, i.e., from outside the road construction machine, and thus, for example, adjust the road construction machine from the deactivation state to the activation state and/or activate the stationary warm-up mode.

### BRIEF DESCRIPTION OF THE DRAWINGS

In the following, the invention is illustrated in more detail with reference to the embodiments shown schematically in the figures. In the figures:

FIG. 1A is a side view of a road construction machine of the ride-on ground compaction machine type;

FIG. 1B is side view of a road construction machine of the compact milling machine type;

FIG. 2 shows a part of a hydraulic system in a first embodiment;

FIG. 3 shows a part of a hydraulic system in a second embodiment;

FIG. 4 shows a part of a hydraulic system in a third embodiment;

FIG. 5 shows a control device and other components, in particular for controlling the embodiments shown in FIGS. 2 to 4;

FIG. 6 shows operating states of a road construction machine in a stationary warm-up mode;

FIG. 7 shows operating states of a road construction machine also in an operational warm-up mode; and

FIG. 8 is a flow diagram of a method for operating a road construction machine.

### DETAILED DESCRIPTION

Identical and/or functionally like elements that are repeated in the figures are not necessarily designated in each figure.

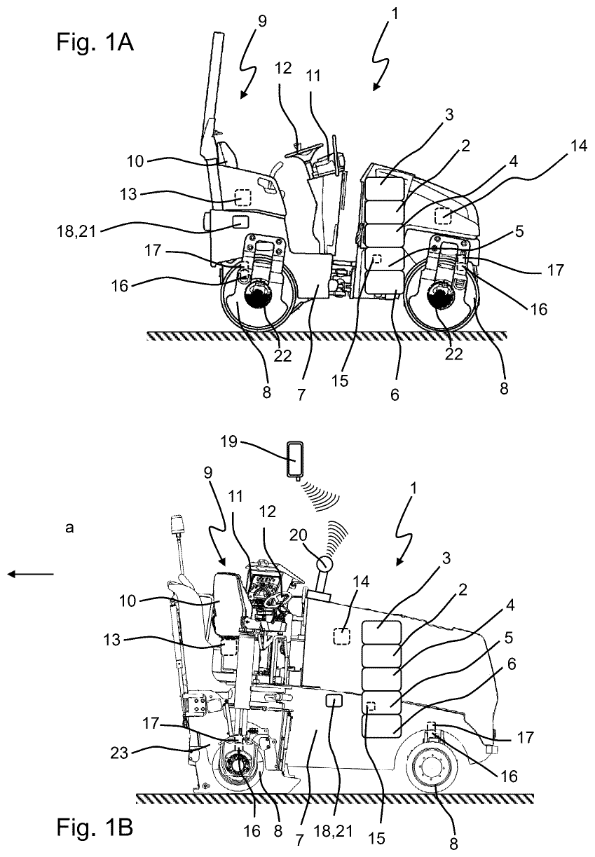

FIGS. 1A and 1B show two illustrative road construction machines 1 of the type relevant here in two specific configurations. FIG. 1A shows a road construction machine of the ride-on ground compaction machine type and FIG. 1B shows a road construction machine of the compact milling machine type. Both road construction machines comprise an electrohydraulic drive system with an electric motor 2 as the drive unit, which is connected to an energy storage device 3 configured to store electrical energy, in particular an accumulator. The electric motor 2 may therefore draw electrical drive energy from the energy storage device 3. The electric motor 2 drives at least one hydraulic pump 4 and may, for example, be connected directly to the electric motor 2 or be connected via a suitable, in particular mechanical, drive gearbox. When driven, the hydraulic pump 4 driven by the electric motor 2 delivers hydraulic fluid within a hydraulic system 5 into a hydraulic fluid reservoir 6, in particular a hydraulic fluid tank. Part of the hydraulic system 5 is also a throttle valve 15, described in more detail below, which can be adjusted between a passive position and at least one warm-up position. The adjustment of the throttle valve can be controlled by a control device 14.

Both of the road construction machines 1 shown in FIGS. 1A and 1B also have a machine frame 7 as an essential support structure, wherein the machine frame of the embodiment shown in FIG. 1A is an articulated machine frame 7 with an articulated joint, in particular an articulated pendulum steering joint, connecting a front frame and a rear frame of the machine frame 7. FIG. 1B, on the other hand, shows a rigid frame with travel units 8 that can be at least partially steered relative to the machine frame 7. The travel units 8 may be wheels (FIG. 1B) or crawler tracks. Alternatively, the travel units may also be roller drums (FIG. 1A). The road construction machines further include an operator platform 9 with a driver's seat 10 and control elements 11, such as a steering wheel of a steering device 12. When the operator sits in the driver's seat 10 on the operator platform 9, he is in the intended operating position. FIGS. 1A and 1B already illustrate that it is also possible to reach individual control elements from outside the respective road construction machine 1, for example from a position standing next to the road construction machine 1. These positions do not represent the intended operating position of the respective road construction machine 1.

The operator platform 9 may have an operator detection device 13, with which it is possible to monitor whether or not an operator is in the operating position on the operator platform 9. This device may be a seat contact switch, for example. The operator detection device 13 may be in signal connection with the control device 14, in particular a machine control system, which controls, among other things, operation of the electric motor 2.

A parking brake device 16 is also part of the road construction machine 1. This device can be adjusted between a braking position, in which the travel units 8 are blocked, and a release position, in which the travel units 8 can rotate about their respective rotation axes (free or driven). The parking brake device 16 may comprise one or more mechanically acting braking elements, which directly or indirectly effect a blockage of the respective travel unit 8 via a frictional contact and/or positive engagement in the braking position. The road construction machine also comprises a braking state detection device 17, which is configured to determine whether the parking brake device 16 is currently in the braking position and/or in the release position. The braking state detection device is in signal connection with the control device 14.

In addition to the parking brake device 16, the road construction machine 1 may also have a service brake device, not shown in detail in the figures, which can be used to brake the road construction machine during traveling operation.

Finally, both of the road construction machines in FIGS. 1A and 1B have a machine activation device 18 with an actuating device 21. This device is configured to adjust the road construction machine 1 between an activation mode and a deactivation mode. In particular, the machine activation device, or its actuating device 21, may be arranged at a point on the road construction machine 1 that can be reached from outside the road construction machine 1, in particular at least from outside the operator platform 9. The machine activation device 18 may, for example, be configured as a button or other manually operable element on the road construction machine 1, for example also as a numeric keypad for entering an authorization code. Additionally or alternatively, it is also possible for the machine activation device 18 to have a mobile unit 19, such as a smartphone, as a control element. Said mobile unit may be in signal transmission connection with the road construction machine 1, which has a suitable receiving device 20 for this purpose, which may also be configured for bidirectional communication. The machine activation device 18 may be in signal connection with the control device 14.

The two road construction machines in FIGS. 1A and 1B differ, among other things, in the type of working equipment and thus in their tasks. The road construction machine 1 according to FIG. 1A may comprise, in addition to the travel units configured as roller drums, in particular hydraulically driven vibration exciters 22, in particular imbalance exciters, and is used to compact the underlying ground. The main working equipment of the road construction machine 1 shown in FIG. 1B, on the other hand, is a milling drum, in particular a hydraulically driven milling drum (concealed by the milling drum box 23 in FIG. 1B), which can be used to mill off a ground layer to a milling depth.

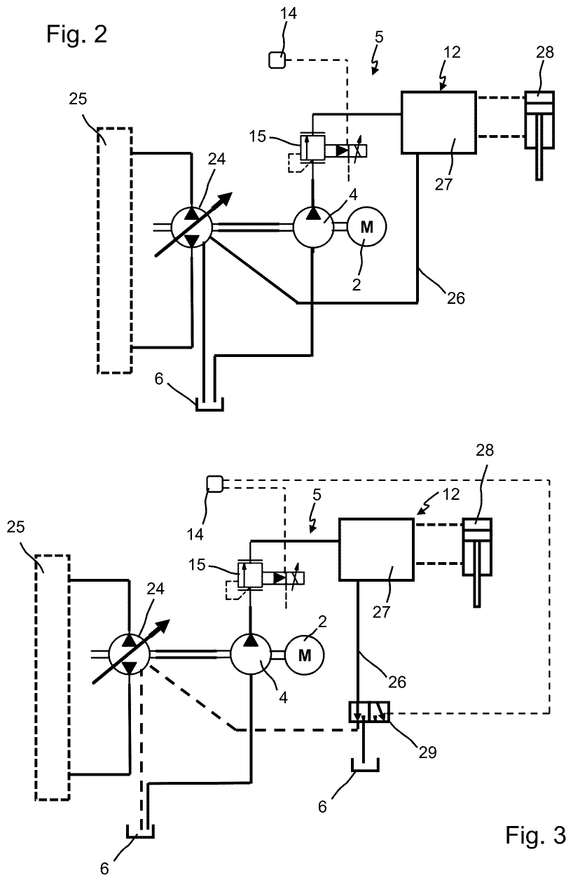

FIGS. 2, 3 and 4 now illustrate further details of various embodiment examples of the invention using the respective hydraulic systems 5 shown.

In FIG. 2, a traction drive hydraulic pump 24 is included in the hydraulic system 5. This pump may be configured as a variable displacement pump with a variable delivery volume per revolution or as a fixed displacement pump with a constant delivery volume per revolution. The traction drive hydraulic pump delivers hydraulic fluid from the hydraulic fluid reservoir 6 into a traction drive hydraulic circuit 25, via which, for example, the travel units 8 indicated in FIGS. 1A and 1B can be driven, in particular by means of suitable hydraulic motors, in order to achieve self-propelled operation of the road construction machine 1. There is also a steering hydraulic circuit 26, which may include, for example, a steering orbitrol 27 and a hydraulically adjustable steering actuator 28. The hydraulic pump 4, in this case the steering hydraulic pump, is driven by the electric motor 2. In the present embodiment example, there is also a drive-through mechanism 29, which is used to also drive the traction drive hydraulic pump 24. The pumps 4 and 24 are thus positioned in a tandem arrangement and are driven jointly by the one electric motor. Irrespective of this particular embodiment example, an intermediate coupling element or the like, not shown in FIG. 2, may also be provided in the drive train between the electric motor 2 and in particular the traction drive hydraulic pump 24 in order to be able to mechanically interrupt the drive train between the electric motor 2 and at least the traction drive hydraulic pump 24 at least temporarily. The hydraulic pump 4 in particular is thus also driven via the electric motor 2, so that an electrohydraulic drive system is present overall, in this case for both steering and traction drive.

FIG. 2 illustrates that the throttle valve 15 is positioned in the hydraulic system 5 such that hydraulic fluid delivered by the hydraulic pump 4 first passes the throttle valve 15 and is delivered back into the hydraulic fluid reservoir 6 via the steering orbitrol 27 in the present embodiment example. The throttle valve 15 can be adjusted between the passive position and at least one warm-up position under the control of the control device 14. In the passive position, the hydraulic fluid passes through the throttle valve in the direction towards the steering orbitrol 27 with virtually no additional flow resistance generated by the throttle valve 15. In the warm-up position, on the other hand, the throttle valve narrows the flow cross-section compared to the flow cross-section provided by the throttle valve 15 in the passive position. This creates a throttling effect through the throttle valve within the hydraulic circuit 26, which ultimately heats the hydraulic fluid flowing through the throttle valve. In the present case, this effect is not only used to heat the hydraulic fluid itself, but, by passing the heated hydraulic fluid downstream of the throttle valve 15 through the steering orbitrol and then passing the hydraulic fluid through the traction drive hydraulic pump 24 transversely to the traction drive hydraulic circuit 25 (i.e., without a pump drive effect on the traction drive hydraulic pump 25 and without significant feed into the traction drive hydraulic circuit 25 for drive purposes), also to heat individual hydraulic components per se by means of thermal convection.

In contrast to the embodiment example shown in FIG. 2, the embodiment example shown in FIG. 3 is characterized by the presence of a switching valve 29. Said valve may, for example, be positioned downstream of the steering orbitrol 27. Depending on the switching position, the hydraulic fluid may be fed directly back into the hydraulic fluid reservoir 6 and/or to the traction drive hydraulic pump 24 in the manner described in FIG. 2. This variant has the advantage that, for example, the targeted heating of specific areas of the overall hydraulic system of the road construction machine 1 and/or the total volume of the hydraulic fluid, in which, for example, heating losses due to heat transfer from the heated hydraulic fluid to one or more components of the hydraulic system 5 can be avoided, can be selectively influenced. This valve 29 may likewise be in signal connection with the control device 14.

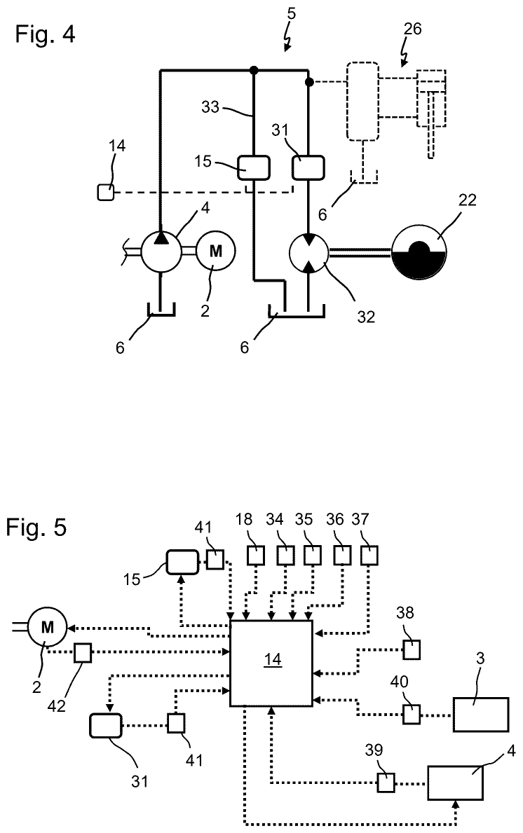

The embodiment example according to FIG. 4 differs from the embodiment examples of FIGS. 2 and 3 by the fact that a working unit hydraulic circuit is used instead of the steering hydraulic circuit, in this case, for example, the drive hydraulic circuit of a vibration exciter 22, in particular comprising at least one or more so-called imbalance exciters. In the case of a road construction machine 1 configured as a road milling machine, in particular a compact milling machine, this may be for a milling drum or the milling drum drive, for example. It is desirable that this working unit is not operated during the warm-up mode, which is described in more detail below. To ensure this, a shut-off valve 31 is included in the present case, which can be adjusted upstream of the hydraulic drive motor 32 of the vibration exciter 22 (or of the drive of the respective working unit) as desired between at least one shut-off position and an open position, in particular by the control device 14. In the shut-off position, the shut-off valve prevents any flow of hydraulic fluid to the drive motor 32 so that the latter is not driven. In the open position, on the other hand, the hydraulic fluid delivered by the hydraulic pump 4 can flow to the drive motor 32 and thus drive it. If the shut-off valve 31 is in the shut-off position, in the present embodiment example the hydraulic fluid is conducted through a bypass line 33, through which the hydraulic fluid bypasses the drive motor 32, in particular at least with respect to a drive effect (“cross-flushing” of the type described above for FIGS. 2 and 3 may also be provided for the drive motor 32), and conducted to and through the throttle valve 15, which in this case is thus arranged in the bypass line 33. Similarly, a steering hydraulic circuit 26 or another hydraulic circuit may be bypassed additionally or alternatively, as indicated in dashed lines in FIG. 4. Instead of the shut-off valve 31, the drive motor 32 may also be configured as a variable displacement motor with a variable capacity per revolution.

FIG. 5 illustrates details of the possible integration of the control device 14 for carrying out the method according to the invention.

It is possible for the control device to receive several status signals that are transmitted from suitable sensors to the control device 14 via suitable signal lines. For example, the machine activation device 18 may be in signal connection with the control device 14 directly or via a sensor and transmit whether the machine activation device 18 is in the activation and/or deactivation state and/or a change from one state to the other state takes place. Furthermore, a status sensor 34 may be included in the braking state detection device 17, which determines and monitors whether the parking brake device 16 is in the braking position and/or in the release position and/or a change between these positions takes place. A service brake sensor, not shown in detail in the figures, may also be provided, which determines the operating state of a service brake and/or a brake request and transmits it to the control device 14. Furthermore, a temperature sensor 35 (and/or a sensor which, in addition to or as an alternative to the temperature, determines a state parameter influencing the current viscosity of the hydraulic fluid) may be present, which determines the current temperature of the hydraulic fluid at one or more suitable points within the hydraulic system 5. Additionally or alternatively, a sensor 36 may also be included which determines an operating parameter dependent on the current viscosity of the hydraulic fluid, such as a torque required for delivering the hydraulic fluid, or a load sensor or the like. A sensor 37 may also be provided which, as part of the operator detection device 13, determines whether or not an operator is currently in the operating position. Additionally or alternatively, a travel speed sensor 38 may be provided, which can be used to determine the current travel speed of the road construction machine 1. A pump sensor 39 may also be included, which determines the operating state of the hydraulic pump 4. The current state of charge of the energy storage device 3 can be determined by means of a state of charge sensor 40 and transmitted to the control unit 14.

The control device 14 controls or regulates the throttle valve 15 or adjusts it between the passive position and one or more warm-up positions, taking into account and depending on the above-mentioned sensor information available in each case. This may be limited to the stationary warm-up mode or optionally also take place in an operational warm-up mode. Furthermore, the control device may also control and/or regulate operation of at least the hydraulic pump 4.

If one or more shut-off valves 31 are included in the road construction machine 1 in the manner described above, the control device 14 may also control the position or setting of these shut-off valves 31.

Both the throttle valve 15 and the shut-off valve(s) may either only be adjustable between two positions or may be adjustable within a range, particularly with regard to the warm-up position or the shut-off position. It is therefore possible for both the throttle valve 15 and the shut-off valve(s) 31 that a valve sensor is provided in each case, which is configured to determine the current position of the respective valve.

Finally, the control device 14 may also control the electric motor 2. Additionally, an operating state sensor 42 may be provided, via which at least one operating parameter of the electric motor 2, for example its speed, and/or at least one operating state of the electric motor 2, for example whether it is currently drawing electrical energy or not, can be determined and monitored.

A clutch that may be present may also be controlled by the control device 14, and its current clutch state may be monitored by means of a suitable sensor.

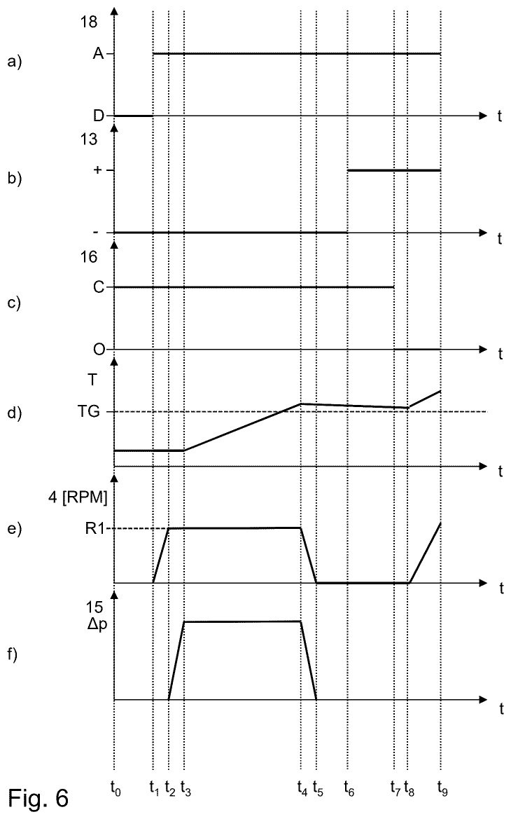

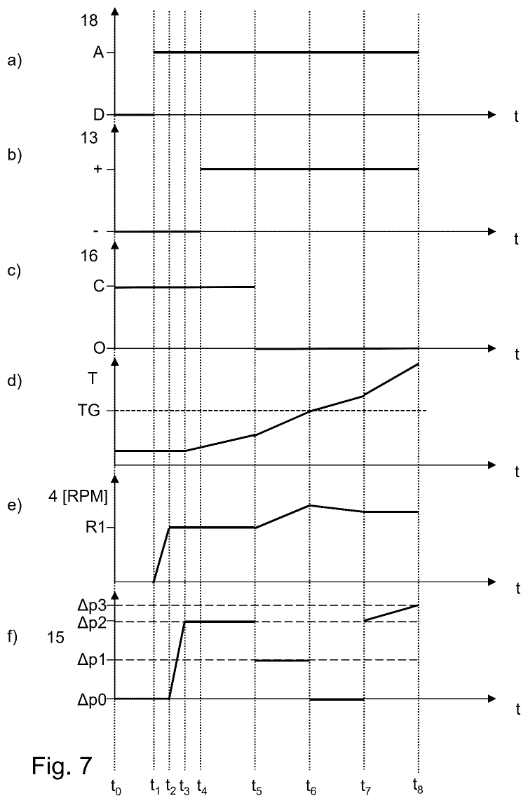

FIGS. 6 and 7 illustrate various operating sequences by way of example, which reflect a possible control and/or regulation behavior of the control device 14, in particular with recourse to the integration of the control device into the road construction machine 1 shown by way of example in FIG. 5. FIG. 6 essentially relates to the stationary warm-up mode, while FIG. 7 also shows operating phases in which the road construction machine is in the operational warm-up mode. In each case, curves of individual control functions and operating and state parameters are shown as a function of time t. The diagrams are schematic and it will be appreciated that the curves shown may vary in practice, in particular some may be more curved.

FIGS. 6 and 7 show at a) the current state of the machine activation device 18 between the deactivation state D and the activation state A. At b) the current state of the operator detection device 13 is shown. Times at which the presence of an operator in the operating position is detected are marked with +. Times when the presence of an operator in the operating position is not detected are marked with −. At c), the current state of the parking brake device 16 is shown, comprising phases C, when the parking brake device is in the braking position, and phases O, when the parking brake device is in the release position. Graph d) indicates the current temperature of the hydraulic fluid at a specific measuring point (or the average value of several measuring points) within the hydraulic system, for example within a line section and/or in the hydraulic fluid reservoir 6. Graph d) further shows a temperature limit TG. It is specified that the viscosity of the hydraulic fluid in the temperature range above this temperature limit TG is sufficiently low or the temperature of the hydraulic fluid is sufficiently high to provide the operator with the desired operating comfort and/or signs of wear on hydraulic components due to excessive viscosity of the hydraulic fluid are sufficiently reduced. Graph e) shows a speed curve (in RPM) of the hydraulic pump 4, wherein in the present embodiment example the hydraulic pump 4 is a fixed displacement pump with a constant displacement per revolution. This means that the volumetric flow rate of the pump and the speed of the pump correlate in this embodiment example. Finally, graph f) indicates the pressure drop Δp of the hydraulic fluid at the throttle valve 15 and thus the current throttling effect compared to the passive position.

The starting point of the operating sequence illustrated in FIG. 6 is the time to, at which the road construction machine 1 is in the deactivation state D and the parking brake device 16 is in the braking position C. If an optional operator detection device is provided, it does not currently detect the presence of an operator in the operating position. Accordingly, the hydraulic pump 4 is also at a standstill so that no hydraulic fluid is delivered within the hydraulic system. The road construction machine can be in this overall state, for example, while it is being transported on a transport vehicle or is parked on a construction site and is not being used.

At the time t₁, the operator switches the road construction machine from the deactivation state D to the activation state A. This may be done, for example, by actuating the actuating device 21 or via the mobile unit 19 or may be triggered by the timer function previously programmed by the operator reaching the time specified for this switchover, so that in this case the manual specification of the switchover by the operator and the actual switchover are offset in time. This may be carried out by the control device 14. When switching to the activation state A, the control device 14 at least queries the current position of the parking brake device 16, which is in the braking position C in the present case. Optionally, the status of the operator detection device 13, which does not detect an operator in the operating position at time t₁, may also be queried. In the present embodiment example, the control device 14 therefore first activates the hydraulic pump 4 at time t₁, which according to e) increases to a set speed R1 defined for the stationary warm-up mode and thereby delivers hydraulic fluid, for example in one of the hydraulic systems as described in FIGS. 2 to 4.

At time t₂, the hydraulic pump 4 reaches its set speed R1 and the control device 13 adjusts the position of the throttle valve 15 from the passive position to the warm-up position. This generates a pressure drop Δp at the throttle valve 15, which reaches its maximum at time t₃. The throttling effect generated converts hydraulic energy into thermal energy, which heats up the hydraulic fluid. The temperature rises accordingly during the period t₃-t₄.

At time t₄, the temperature T reaches the temperature limit TG. The hydraulic fluid has now reached a sufficiently high temperature. In order to save electrical energy, the hydraulic pump is now switched off so that the speed of the hydraulic pump and accordingly the pressure drop at the throttle valve 15 drop back to zero from t₄ to t₅. At this point, it is also possible to maintain a type of circulation state in which, for example, the current speed of the pump is only reduced but kept greater than zero, for example to counteract cooling of the hydraulic fluid in an energy-efficient manner.

At time to, the operator assumes the operating position. This means that up to time to the operator was not present in the operating position and was not required. However, by assuming the operating position, the operator now indicates that he probably wants to put the road construction machine 1 into traveling and/or working operation. This may additionally or alternatively also be done by releasing the parking brake device at time t₇ or by adjusting the parking brake device 16 from the braking position C to the release position O, and may be indicated to the control device 14, for example in the manner described above.

Only at time t₇ can the road construction machine be regularly operated by the operator in the operating position and the stationary warm-up mode is ended (and possibly switched to the operational warm-up mode). At time t₈, the operator enters a travel command. Accordingly, the control device controls an increase in the speed of the hydraulic pump according to e), which may ultimately cause the current temperature of the hydraulic fluid to rise further (t₈ to t₉). However, since in this case the current temperature of the hydraulic fluid is still above the temperature limit TG, additional heating of the hydraulic fluid via the throttle valve 15 is not necessary in the constellation shown in FIG. 6 at time t₈.

FIG. 7 also starts with the road construction machine in the deactivation state, as already explained for FIG. 6. Up to time t₃, the curves are identical and the machine is in stationary warm-up mode. In contrast to FIG. 6, however, the operator now assumes his operating position at time t₄ and releases the parking brake device 13 or moves it to the release position at time t₅. At time t₅, however, the hydraulic fluid has not yet exceeded the temperature limit TG and has therefore not yet reached its set temperature. The control device 14 therefore switches from the stationary warm-up mode to the operational warm-up mode. Specifically, for example, the throttle valve is moved from the warm-up position at time t₄, where a pressure drop Δp2 is generated at a given reference speed of the hydraulic pump, to another warm-up position in which a comparatively lower pressure drop Δp1 is generated. This is the case between t₅ and t₆. In the Δp2 position, the flow cross-section now provided by the throttle valve 15 is therefore smaller than in the Δp1 position. At the same time, the operator starts traveling and working operation of the road construction machine, for which purpose the speed of the hydraulic pump is further increased between t₅ and t₆.

At time t₆, the hydraulic fluid reaches the threshold indicated by TG, so that further heating of the hydraulic fluid is no longer necessary during the current operation of the road construction machine in the operational warm-up mode. The control device 14 adjusts the throttle valve to the passive position (Δp0) and reduces the speed of the hydraulic pump by the amount of hydraulic power that was required to deliver the hydraulic fluid through the throttle valve when previously in the warm-up position Δp1. Due to the traveling and working operation of the road construction machine, the hydraulic fluid may increase even further above the temperature limit regardless of the throttling effect of the throttle valve, as can be seen, for example, during the period t₆-t₇.

A new event now occurs at time t₇. A request signal is transmitted to the control device 14 to generate an additional braking torque, for example from a service braking device not shown in detail in the figures. This causes the control device to adjust the throttle valve to a further position with a throttling effect (variable and increasing from Δp2 to Δp3), even though the temperature of the hydraulic fluid is above TG at this point. However, in this case the control device 14 prioritizes the requested braking torque over the temperature management of the hydraulic fluid.

FIG. 7 illustrates that the throttle valve can be adjusted to more than one warm-up position and, in particular, may be used not only for heating purposes, but may also be assigned multiple functions. In particular, the throttle valve or its warm-up position may be variable and also controllable within an adjustment range.

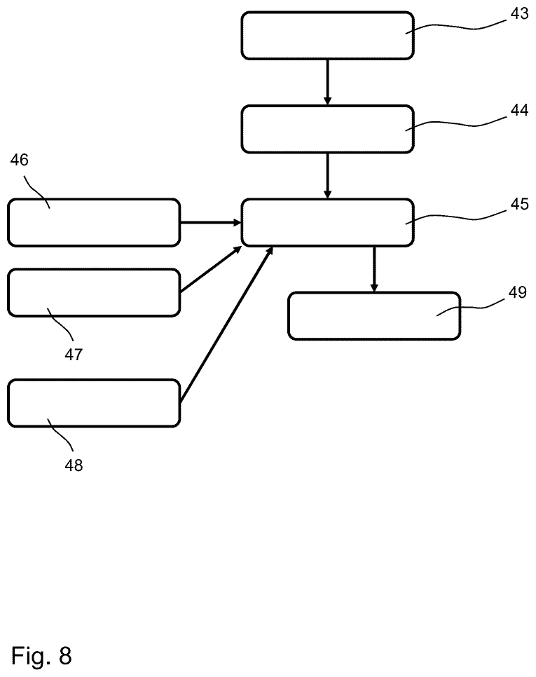

Finally, FIG. 8 shows a flow chart illustrating various possible sequences of the method according to the invention, in particular for operating the embodiment examples shown in the preceding figures.

In a step 43, the method comprises adjusting the machine activation device from the deactivation state to the activation state by the operator of the ground compaction machine. Step 44 comprises detecting and transmitting to the control device 14 whether the parking brake device 16 is in the braking position or the release position by the braking state detection device 17. In the stationary warm-up mode, step 45 then comprises controlling the position of the throttle valve 15 between the passive position and the warm-up position by the control device 14 when the road construction machine 1 is in the activation state, depending on detection signals from the braking state detection device, wherein at least if the parking brake device is in the activated braking position, the control device activates the delivery of hydraulic fluid by the hydraulic pump driven by the electric motor and adjusts the throttle valve to the at least one warm-up position. In the present case, it is therefore at least necessary for the machines to be in the activation state and for the parking brake device 16 to be in the braking position at the same time in order to put the hydraulic pump 4 into operation for heating purposes.

Step 45, i.e., the activation of the hydraulic pump by the control device, may optionally only be carried out as long as a state parameter influencing the current viscosity of the hydraulic fluid and/or an operating parameter dependent on the current viscosity of the hydraulic fluid is outside a defined range, in particular the temperature of the hydraulic fluid is below a temperature limit. Accordingly, a step 46 may comprise monitoring one or more state and/or operating parameters and controlling step 45.

Step 45 may also be used additionally or alternatively to heat the hydraulic fluid for other functions, in particular, for example, to generate a braking torque during traveling and working operation of the road construction machine. If such an additional braking torque is requested, the control device for controlling the position of the throttle valve 15 may prioritize between a “heating requirement” and a “braking requirement” and control the position of the throttle valve in a step 47 depending on this prioritization.

It is also possible that, in order to control the position of the throttle valve, it is also taken into account in a step 48 whether an operator detection device detects the presence and/or absence of an operator in the operating position.

The method may also comprise switching one or more bypass valves in a step 49, for example to bypass hydraulically driven working units in stationary warm-up mode, such as a vibration exciter or a milling drum drive.

What is claimed is:

1. A method for operating a self-propelled road construction machine, in particular a ride-on ground compaction machine, the road construction machine comprising:
an electrohydraulic drive system with an electric motor as a drive unit, which is connected to an energy storage device configured to store electrical energy;
a hydraulic pump which can be driven by the electric motor and which, when driven by the electric motor, delivers hydraulic fluid into a hydraulic fluid reservoir via a hydraulic system;
a controllable throttle valve within the hydraulic system, wherein the throttle valve is adjustable between a passive position and at least one warm-up position;
a control device which controls the adjustment of the throttle valve between the passive position and the at least one warm-up position;
a machine activation device which can be adjusted to adjust the road construction machine between an activation state and a deactivation state by an operator of the road construction machine;
a parking brake device adjustable between a braking position and a release position and a braking state detection device configured at least for detecting an activated braking position and/or an activated release position of the parking brake device; and
the method further comprising the following steps for heating hydraulic fluid:
a) adjusting the machine activation device from the deactivation state to the activation state by the operator of the road construction machine;
b) detecting and transmitting to the control device whether the parking brake device is in the braking position or the release position by the braking state detection device;
c) in a stationary warm-up mode, controlling the position of the throttle valve between the passive position and the warm-up position by the control device when the road construction machine is in the activation state, depending on detection signals from the braking state detection device, wherein at least if the parking brake device is in the activated braking position, the control device activates the delivery of hydraulic fluid by the hydraulic pump driven by the electric motor and adjusts the throttle valve to the at least one warm-up position.

2. The method according to claim 1, wherein the hydraulic pump is only activated by the control device if a state parameter influencing the current viscosity of the hydraulic fluid and/or an operating parameter dependent on the current viscosity of the hydraulic fluid is outside a defined range, in particular the temperature of the hydraulic fluid is below a temperature limit, and/or deactivation of the activated hydraulic pump by the control device takes place if a status parameter influencing the current viscosity of the hydraulic fluid and/or an operating parameter dependent on the current viscosity of the hydraulic fluid is within a defined range, in particular the temperature of the hydraulic fluid is above a temperature limit.

3. The method according to claim 1, wherein the throttle valve can be adjusted within a variable adjustment range to at least two different warm-up positions, one warm-up position having a higher throttling effect compared to the other warm-up position.

4. The method according to claim 3, wherein the at least one warm-up position having the higher throttling effect compared to the other warm-up position is set by the control device only if at least the parking brake device is in the activated braking position.

5. The method according to claim 1, wherein the control device, in an operational warm-up mode, if the road construction machine is in the activation state and the parking brake device is in the release position, adjusts the position of the throttle valve to the at least one warm-up position for generating a braking torque and/or for heating hydraulic fluid within at least a part of the hydraulic system.

6. The method according to claim 5, wherein the control device controls the throttling effect of the throttle valve such that it is greater in the stationary warm-up mode than in the operational warm-up mode.

7. The method according to claim 5, wherein the control device controls at least one safety function in relation to at least one hydraulically operable functional unit of the road construction machine in the operational warm-up mode and if the throttle valve is in a warm-up position, and for this purpose initiates an adjustment of the position of the throttle valve to increase the throttling effect of the throttle valve if a higher throttling effect is required compared to the operational warm-up mode in order to obtain the safety function.

8. The method according to claim 5, wherein the control device prioritizes a request signal for generating a braking torque and a request signal for generating a warm-up power in relation to one another in the operational warm-up mode.

9. The method according to claim 1, wherein the road construction machine has an operator platform from which the operator can control the traveling and working operation of the road construction machine, the operator platform having an operator detection device configured to detect the presence and/or absence of an operator in an operating position on the operator platform, wherein the operator detection device is used to detect and transmit to the control device whether the operator is in the operating position on the operator platform, and wherein the throttle valve is also operated by the control device in the stationary warm-up mode and/or in the operational warm-up mode depending on whether or not the operator detection device detects an operator in the operating position.

10. The method according to claim 9, wherein the road construction machine comprises a hydraulically operable steering device, and in that the control device controls the road construction machine in the stationary warm-up mode such that:
a) if the operator detection device does not detect the presence of the operator in the operating position and if the steering device is activated;
a speed of the electric motor is reduced, in particular depending on the current warm-up position of the throttle valve; or
a speed of the electric motor is limited to a maximum permissible steering operating speed; and/or
b) if the operator detection device detects the presence of the operator in the operating position, the electric motor is operated at an idling speed which is higher than at least one of the speeds in a).

11. The method according to claim 1, wherein the hydraulic pump is a steering hydraulic pump, the hydraulic system comprises a traction drive hydraulic pump, and hydraulic fluid delivered by the steering hydraulic pump from the hydraulic fluid reservoir in the stationary warm-up mode is delivered in the hydraulic system through at least a part of a steering hydraulic circuit and from there through at least a part of the traction drive hydraulic pump and from there into the hydraulic fluid reservoir.

12. The method according to claim 1, wherein the hydraulic pump is a vibration exciter drive hydraulic pump, the hydraulic system comprises a vibration hydraulic system with a vibration drive motor driven by the vibration exciter drive hydraulic pump, the controllable throttle valve is arranged in a bypass line to the vibration drive motor, wherein, in the stationary warm-up mode or in the operational warm-up mode, at least a portion of the hydraulic fluid delivered from the hydraulic fluid reservoir by the vibration exciter drive hydraulic pump is delivered through the controllable throttle valve and from there into the hydraulic fluid reservoir while bypassing the vibration drive motor.

13. The method according to claim 1, wherein the control device only permits the stationary warm-up mode if a state of charge of the energy storage device is above a state of charge limit and/or controls the warm-up position of the throttle valve depending on the current state of charge of the energy storage device.

14. A self-propelled road construction machine, in particular a ride-on ground compaction machine, wherein it is configured to carry out the method according to claim 1.

15. A self-propelled road construction machine, in particular a ride-on ground compaction machine, wherein the machine activation device has an operating device that can be operated from outside the operator platform of the road construction machine.
